(19) United States
(12) Patent Application Publication
(10) Pub. No.: US 2011/0048260 A1
(43) Pub. Date: Mar. 3, 2011

(54) ROLLER BODY HAVING A ROLLER COATING FOR IMPROVED INK-WATER-EMULSION FORMATION IN PRINTING UNITS OF WET OFFSET MACHINES AND METHOD FOR THE MANUFACTURING THEREOF

(76) Inventors: Markus Kirst, Buttelborn (DE); Gerhard Johner, Gelnhausen (DE)

(21) Appl. No.: 12/919,346

(22) PCT Filed: Mar. 10, 2009
(86) PCT No.: PCT/EP2009/052752

§ 371 Date: Oct. 27, 2010

(30) Foreign Application Priority Data
Mar. 13, 2008 (DE) 10 2008 014 034.1

(51) Int. Cl. B41F 31/00; B05D 3/12; C23C 4/04; C23C 4/10

(52) U.S. Cl. 101/349.1; 427/247; 427/452

(57) ABSTRACT

There is provided a roller body made of steel, aluminium or carbon fibre reinforced plastic material, which, in printing units of wet offset machines, are in direct contact to the dampening form roller and which serve the formation of a stable ink-water-emulsion. There is further provided a method for producing such roller bodies. In conformity with the invention the roller body is provided with a porous coating of highly wear-resistant oxide ceramics or of wear-resistant hard metal, wherein pores that are open towards the circumferential surface of the roller body, are formed in the layer matrix of the coating preferably by applying the porous coating by a thermal spray process or an other coating process, and by subsequently grinding the coating to size to thereby open pores in the layer matrix. The surfaces produced in this manner preferably have a stable roughness of

1.0 μm<R_{z}<500 μm, in particular R_{z}=5 μm to 25 μm. The thicknesses of the porous coating preferably ranges from 25 μm to 2000 μm, and most preferably amounts to about 150 μm.

### BACKGROUND OF THE INVENTION

1. Field of the Invention

The invention relates to roller bodies made of steel, aluminium or carbon fibre reinforced plastic material in printing units of wet offset machines, having a roller coating, the objective of which is to guarantee the formation of a stable ink-water-emulsion. The invention further relates to a method for the manufacturing of such coated roller bodies.

2. Description of Related Art

According to the prior art such roller bodies are provided with matted chromium coatings (see roller assembly according to FIG. 1) or with RILSAN® coatings (usual product name in offset machines for coatings from the group of polyamides, see roller assembly according to FIG. 2). The latter coatings are regarded as lipophilic and wear-resistant and very often show a very smooth surface, in particular if the printing unit operates with highly-pigmented ink or even zinc white including titanium dioxide pigments. Already after a short operation, highly pigmented inks very often have the effect, that even layers of matted chromium are heavily smoothened and lose the desired surface roughness. Neither a smoothened coating of matted chromium nor a smooth RILSAN® coating are able to form in a sufficient quantity the stable ink-water-emulsion which is necessary for the printing process, with the consequence, that according to the prior art emulsification aids in the form of isopropyl alcohol and/or tenside-containing additive are added to the fountain solution. These additional measures are as such undesirable, because they are cost-increasing and damaging to the environment (isopropyl alcohol is regarded as damaging the atmosphere and is a volatile organic compound). Moreover, in the practice of low-isopropyl or isopropyl-free printing it turned out that partly not before weeks of operation of the printing unit, an increase in the concentration of the tenside-containing additives leads to an overturning of the printing process, because there is no longer a “water-in-ink-emulsion”, but rather an “ink-in-water-emulsion”; the latter, of course, wets not only the ink-containing zones on the printing plate, but also the water-containing zones, so that not print pattern is produced on the paper to be printed, but only an uncontrolled inking.

Therefore, the invention aims at providing coated roller bodies of steel, aluminium or fibre reinforced plastic material, which in wet offset machines are in close contact to the dampening form roller and which serve the formation of a stable ink-water-emulsion, which coated roller bodies have a wear-resistant surface the topography of which does not change during the printing machine operation even if inks with many pigments which may have very abrasive effects are processed, and which coated roller bodies permanently maintain a sufficiently high roughness. Furthermore, the invention is intended to provide for a relatively simple and cost-effective method for the manufacturing of such coated roller bodies.

### SUMMARY OF THE INVENTION

The objective of the invention is solved according to claim 1 as well as by the method according to claim 6.

A roller body is made of steel, aluminium or carbon fibre reinforced plastic material, which roller body is in direct contact with a dampening form roller in printing units of wet offset machines for improved ink-water-emulsion formation. A coating is provided made of highly wear-resistant oxide ceramics or of wear-resistant hard metal, wherein pores which are open towards the circumferential surface of the roller body, are provided in a layer matrix of the coating

In particular, the roller bodies of steel, aluminium or fibre reinforced plastic materials to be coated, which in wet offset machines are in direct contact with the dampening form roller, are provided with a porous coating made of highly wear-resistant oxide ceramics such as, for example, Al2O3, Cr2O3, TiO2, SiO2 or ZrO2 or mixtures thereof, or made of wear-resistant hard metal such as for example, WC/Co, Cr3C2/NiCr, NiCrBSi, WC/Ni, TiC/Ni, molybdenum, chromium etc., which coating preferably is applied by means of a thermal spraying method and is subsequently ground to size, so that pores in the matrix of the layer are opened.

The surfaces produced in this process preferably show roughnesses of 1.0 μm<Rz<500 μm, in particular Rz=5 μm to 25 μm. The thicknesses of the porous coatings according to the invention preferably range from 25 μm to 2000 μm, preferably at about 150 μm. The porous coating according to the present invention made of oxide ceramics or hard metal does not have to be applied by thermal spraying, but may also be applied by means of coating methods such as PVD (Physical Vapour Deposition), CVD (Chemical Vapour Deposition), sintering, enamelling, hot isostatic pressing, electroplating, explosion cladding, build up welding, build up brazing, adhesion methods or reactive processes. If the roller body to be coated is made of fibre reinforced plastic material and the coating process involves a thermal spraying process, it preferably has to be taken into account that a circumferential velocity of at least 0.2 m/s is observed and cooling processes are applied, which keep the fibre reinforced plastic material below 200° C., because otherwise a delamination may occur.

These and further objects, features and advantages of the present invention will become apparent from the following description when taken in connection with the accompanying drawings which, for purposes of illustration only, show several embodiments in accordance with the present invention.

### BRIEF DESCRIPTION OF THE DRAWINGS

FIG. 1 shows an emulsification aid in the form of a distributor cylinder.

FIG. 2 shows an emulsification aid in the form of a porously coated tandem roller.

### DETAILED DESCRIPTION OF THE INVENTION

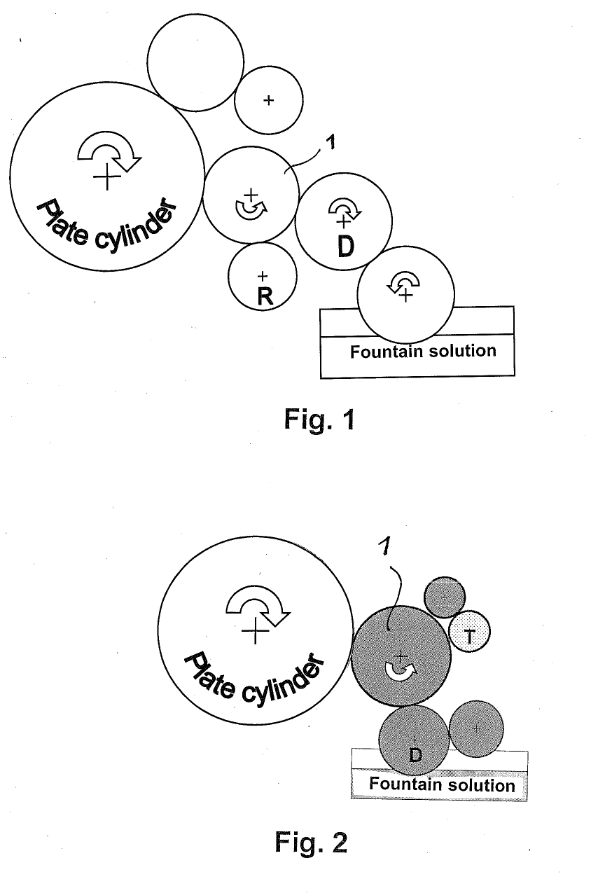

In FIG. 1 an emulsification aid in the form of a distributor cylinder R designed in the above-described manner is shown, which is positioned below a dampening form roller 1 of a wet offset machine. As is known, an ink-water-emulsion is applied onto a plate cylinder by the dampening form roller 1.

FIG. 2 shows an emulsification aid in the form of a porously coated tandem roller T on the dampening form roller 1.

While various embodiments in accordance with the present invention have been shown and described, it is understood that the invention is not limited thereto, and is susceptible to numerous changes and modifications as known to those skilled in the art. Therefore, this invention is not limited to the details shown and described herein, and includes all such changes and modifications as encompassed by the scope of the appended claims.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. A use of a roller body for improved ink-water-emulsion formation in printing units of wet offset machines, which roller body is in direct contact with the dampening form roller of the printing units of wet offset machines, the roller body being made of steel, aluminum or carbon fiber reinforced plastic material, characterized by a coating of the roller body being made of highly wear-resistant oxide ceramics or of wear-resistant hard metal, wherein pores which are open towards the circumferential surface of the roller body, are provided in the layer matrix of the coating.

16. The use as claimed in claim 15, characterized in that the porous coating has a surface roughness of 1.0 μrn<R_{z}<500 μrn, in particular a surface roughness R_{z} of 5 μrn to 25 μrn.

17. The use as claimed in claim 15, characterized in that the porous coating consists of Al₂O₃, Cr₂O₃, TiO₂, SiO₂ or ZrO₂ or of mixtures thereof.

18. The use as claimed in claim 15, characterized in that the porous coating consists of WC/Co, Cr₃C₂/NiCr, NiCrBSi, WC/Ni, TiC/Ni, molybdenum, chromium or of mixtures thereof.

19. The use as claimed in claim 15, characterized in that the porous coating has a thicknesses of 25 μrn to 2000 μrn, preferably a thicknesses of about 150 μrn,

20. A method for manufacturing a roller body which body is in direct contact with the dampening form roller in printing units of wet offset machines for improved ink-water emulsion formation, characterized in that a porous coating of highly wear-resistant oxide ceramics or of wear-resistant hard metal is formed and subsequently is ground to size thereby opening pores in the matrix of the layer.

21. The method as claimed in claim 20, characterized in that the porous coating is ground to size to a surface roughness of 1.0 μrn<R_{Z}<500 μrn, in particular a surface roughness R, of 5 μrn to 25 μrn.

22. The method as claimed in claim 20, characterized in that the porous coating is made from Al₂O₃, Cr₂O₃, TiO₂, SiO₂ or ZrO₂ or of mixtures thereof.

23. The method as claimed in claim 20, characterized in that the porous coating is made from WC/Co, Cr₃C₂/NiCr, NiCrBSi, WC/Ni, TiC/Ni, molybdenum, chromium or of mixtures thereof.

24. The method as claimed in claim 20, characterized in that the porous coating is formed to have a thicknesses of 25 μrn to 2000 μrn, preferably a thicknesses of about 150 μrn,

25. The method as claimed in claim 15, characterized in that the porous coating is formed by a thermal spray process.

26. The method as claimed in claim 25, characterized in that a circumferential velocity of at least 0.2 m/s is maintained during the thermal spray process.

27. The method as claimed in claim 20, characterized in that PVD (Physical Vapour Deposition), CVD (Chemical Vapour Deposition), sintering, enamelling, hot isostatic pressing, electroplating, explosion cladding, build up welding, build up brazing, adhesion methods or reactive processes is used as coating process in producing the porous coating.

28. The method as claimed in claim 20, characterized in that in applying the porous coating on a roller body of carbon fiber reinforced plastic material, the temperature of the roller body is kept by cooling measures at less than 200° C. in order to avoid delamination.

29. The use of a coating for manufacturing a roller body which body is in direct contact with the dampening form roller in printing units of wet offset machines for improved ink water-emulsion formation, characterized in that the coating is a porous coating of highly wear-resistant oxide ceramics or of wear-resistant hard metal which is formed and subsequently ground to size thereby opening pores in the matrix of the layer.
